(19) United States
(12) Patent Application Publication
(10) Pub. No.: US 2019/0100181 A1
(43) Pub. Date: Apr. 4, 2019

(54) BRAKING DEVICE FOR VEHICLE

(71) Applicant: ADVICS CO., LTD., Kariya-shi, Aichi-ken (JP)

(72) Inventors: Tatsushi Kobayashi, Kariya-shi, Aichi-ken (JP); Takayuki Yamamoto, Nagakute-shi, Aichi-ken (JP); Yasuhito Ishida, Toyokawa-shi, Aichi-ken (JP); Kunihiro Nishiwaki, Toyota-shi, Aichi-ken (JP)

(73) Assignee: ADVICS CO., LTD., Kariya-shi, Aichi-ken (JP)

(21) Appl. No.: 16/082,143

(22) PCT Filed: Mar. 28, 2017
(86) PCT No.: PCT/JP2017/012730

§ 371 Date: Sep. 4, 2018

(30) Foreign Application Priority Data
Mar. 29, 2016 (JP) 2016-066595

(51) Int. Cl. B60T 8/48; B60T 8/36; B60T 8/1761; B60T 8/26

(52) U.S. Cl. CPC B60T 8/48; B60T 8/268; B60T 8/1761; B60T 8/368

(57) ABSTRACT

This invention is characterized in being provided with: a determining unit for determining the execution of a state transition from a pressure increase mode in which an electric pump is operated with a differential valve being in a closed state and a holding valve being in an open state to a pressure decrease mode in which the electric pump is operated with the holding valve being in a closed state and the differential valve being in an open state; and a control unit for controlling, when the determining unit determines the execution of the state transition, one or more of the differential valve, the holding valve, a pressure reduction valve, and the electric pump, and reducing the amount of a braking fluid retained in a path between the differential valve and the holding valve.

### TECHNICAL FIELD

The present invention relates to a braking device for a vehicle.

### BACKGROUND ART

According to a brake system disclosed in Patent Literature 1, in a state (hereinafter referred to as the bottoming state) where a forward movement of a master piston sliding in a master cylinder is regulated by the master cylinder, a braking fluid in a reservoir arranged in the master cylinder is suctioned through a check valve arranged in the master cylinder and is supplied to a wheel cylinder by a pump arranged between the master cylinder and the wheel cylinder. Enlargement of the master cylinder and lowering of deceleration in a fade state are thereby suppressed.

### CITATIONS LIST

### PATENT LITERATURE

Patent Literature 1: Japanese Unexamined Patent Application Publication No. 2013-71714

### SUMMARY OF INVENTION

### Technical Problems

When a fade state is obtained and an operator feels lack of braking force, the braking force operation amount is increased, and as a result, a bottoming state is obtained. When the lowering of deceleration is suppressed using the technique of Patent Literature 1, an actuator is driven with a cut valve arranged on a path between the master cylinder and the wheel cylinder in a closed state and a pressure increase valve arranged on the wheel cylinder side of the cut valve in an open state to supply the braking fluid to the wheel cylinder (hereinafter referred to as bottoming control).

A case in which an antiskid control is started during the bottoming control can be considered. In this case, a wheel cylinder pressure needs to be reduced, and thus a control is carried out so that the pressure increase valve is in the closed state and a pressure reduction valve is in the open state. When the pressure reduction valve is in the open state, the braking fluid is accumulated in the interior reservoir, and hence the braking fluid is suctioned by the pump and is discharged between the cut valve and the pressure increase valve. The cut valve is to be transitioned from the closed state to the open state to prevent the path between the cut valve and the pressure increase valve from becoming to have a higher pressure, but the path between the cut valve and the pressure increase valve temporarily becomes to have a higher pressure due to a response delay of the cut valve. Durability of the device thus may lower.

In light of the foregoing, it is an object of the present invention to provide a braking device for a vehicle capable of ensuring sufficient durability even when a state is transitioned from a pressure increase mode (e.g., the bottoming control) to a pressure reduction mode (e.g., the antiskid control).

### Solutions to Problems

To respond to such a request, a present invention provides a braking device for a vehicle including: a master cylinder that converts a required braking force to a fluid pressure, a wheel cylinder that applies, to a wheel of a vehicle, a braking force corresponding to an input fluid pressure; a differential pressure valve arranged between the master cylinder and the wheel cylinder to adjust a differential pressure between the master cylinder and the wheel cylinder; a holding valve arranged between the differential pressure valve and the wheel cylinder to adjust a communicating state of the differential pressure valve and the wheel cylinder, a reservoir that stores braking fluid; a pressure reduction valve arranged between the wheel cylinder and the reservoir to adjust a communicating state of the wheel cylinder and the reservoir; an electric pump that ejects the braking fluid in the reservoir to a portion between the differential pressure valve and the holding valve; and a fluid path connected to the reservoir from a master cylinder side of the differential pressure valve, the braking device for the vehicle carrying out a control of the differential pressure valve, the holding valve, the pressure reduction valve, and the electric pump; the braking device for the vehicle including: a determining unit that determines execution of a state transition from a pressure increase mode of activating the electric pump with the differential pressure valve in a closed state and the holding valve in an open state to a pressure reduction mode of activating the electric pump with the holding valve in the closed state and the pressure reduction valve in the open state; and a control unit that carries out the control of any one or more of the differential pressure valve, the holding valve, the pressure reduction valve, and the electric pump as a result of the determination of the execution of the state transition by the determining unit, and reduces an amount of braking fluid to be accumulated in a path between the differential pressure valve and the holding valve.

According to such configurations, when the execution of the state transition from the pressure increase mode (e.g., the bottoming control) to the pressure reduction mode (e.g., the antiskid control) is determined, the control unit reduces the amount of braking fluid to be accumulated in a path between the differential pressure valve and the holding valve, and thus can prevent the path from becoming to have a higher pressure. Therefore, the durability of the braking device for the vehicle can be enhanced.

In the present invention, the control unit executes the state transition from the pressure increase mode to the pressure reduction mode after lowering the differential pressure formed by the differential pressure valve to reduce the amount of the braking fluid to be accumulated in the path between the differential pressure valve and the holding valve.

According to the present invention, before the execution of the state transition from the pressure increase mode to the pressure reduction mode, the differential pressure formed by the differential pressure valve is lowered by the control unit, so that the amount of braking fluid flowing out to the master cylinder from the path between the differential pressure valve and the holding valve increases. As a result, the amount of braking fluid to be accumulated in the path between the differential pressure valve and the holding valve is reduced, and the path can be prevented from becoming to have a higher pressure. Therefore, the durability of the braking device for the vehicle can be enhanced.

In the present invention, the control unit lowers an ejection amount of the electric pump for a predetermined period from a start of the pressure reduction mode to reduce the amount of the braking fluid to be accumulated in the path between the differential pressure valve and the holding valve.

According to the present invention, the amount of braking fluid supplied to the path between the differential pressure valve and the holding valve is reduced, and the path can be prevented from becoming to have a higher pressure by lowering the ejection amount of the electric pump for a predetermined time from the start of the pressure reduction mode. Therefore, the durability of the braking device for the vehicle can be enhanced. Furthermore, the braking fluid in the reservoir can be rapidly suctioned after elapse of the predetermined time from the start of the pressure reduction mode by lowering the ejection amount only for the predetermined time in which the response delay of the differential pressure valve occurs.

In the present invention, the control unit lowers the differential pressure formed by the differential pressure valve when an oil amount in the reservoir becomes greater than or equal to a first threshold value, and activates the electric pump when the oil amount in the reservoir becomes greater than or equal to a second threshold value greater than the first threshold value, for a predetermined period from the start of the pressure reduction mode to reduce the amount of the braking fluid to be accumulated in the path between the differential pressure valve and the holding valve.

According to the present invention, during the predetermined period from the start of the pressure reduction mode in which the response delay of the differential pressure valve occurs, the oil amount of the interior reservoir is increased by the pressure reduction mode, but the second threshold value for activating the electric pump is greater than the first threshold value for lowering the differential pressure formed by the differential pressure valve, and hence the amount of braking fluid accumulated in the path between the differential pressure valve and the holding valve can be reduced, and the path can be prevented from becoming to have a higher pressure before activating the electric pump. Therefore, the durability of the braking device for the vehicle can be enhanced.

In the present invention, the control unit delays the state transition of the holding valve from the open state to the closed state in the state transition from the pressure increase mode to the pressure reduction mode to reduce the amount of the braking fluid to be accumulated in the path between the differential pressure valve and the holding valve.

According to the present invention, in the state transition from the pressure increase mode to the pressure reduction mode, the control unit delays the state transition of the holding valve from the open state to the closed state so that the amount of braking fluid flowing out to the wheel cylinder from the path between the differential pressure valve and the holding valve increases. As a result, the amount of braking fluid to be accumulated in the path between the differential pressure valve and the holding valve is reduced, and the path can be prevented from becoming to have a higher pressure. Therefore, the durability of the braking device for the vehicle can be enhanced.

In the present invention, the control unit delays the state transition of the pressure reduction valve from the closed state to the open state in the state transition from the pressure increase mode to the pressure reduction mode to reduce the amount of the braking fluid to be accumulated in the path between the differential pressure valve and the holding valve.

According to the present invention, in the state transition from the pressure increase mode to the pressure reduction mode, the control unit delays the state transition of the pressure reduction valve from the closed state to the open state so that the speed at which the braking fluid is accumulated in the interior reservoir becomes slower. As a result, the amount of braking fluid supplied to the path by the electric pump is reduced. Therefore, the amount of braking fluid accumulated in the path of immediately after the state transition from the pressure increase mode to the pressure reduction mode is reduced, and the path can be prevented from becoming to have a higher pressure. Therefore, the durability of the braking device for the vehicle can be enhanced.

### BRIEF DESCRIPTION OF DRAWINGS

FIG. 1 is an overall configuration view of a braking device for a vehicle according to the present invention.

FIG. 2 is a cross-sectional view showing a configuration of a second master chamber.

FIG. 3 is an explanatory view describing change in a master pressure and a wheel pressure with respect to a brake operation in a bottoming control.

FIG. 4 is a view showing a response delay of a differential pressure valve in a time chart.

FIG. 5 is a control flow diagram according to the present invention.

FIG. 6 is a view showing a first set example of the present invention in a time chart.

FIG. 7 is a view showing a second set example of the present invention in a time chart.

FIG. 8 is a view showing a third set example of the present invention in a time chart.

FIG. 9 is a view showing a fourth set example of the present invention in a time chart.

FIG. 10 is a view showing a fifth set example of the present invention in a time chart.

### DESCRIPTION OF EMBODIMENTS

An embodiment of a braking device for a vehicle according to the present invention will be described with reference to the drawings.

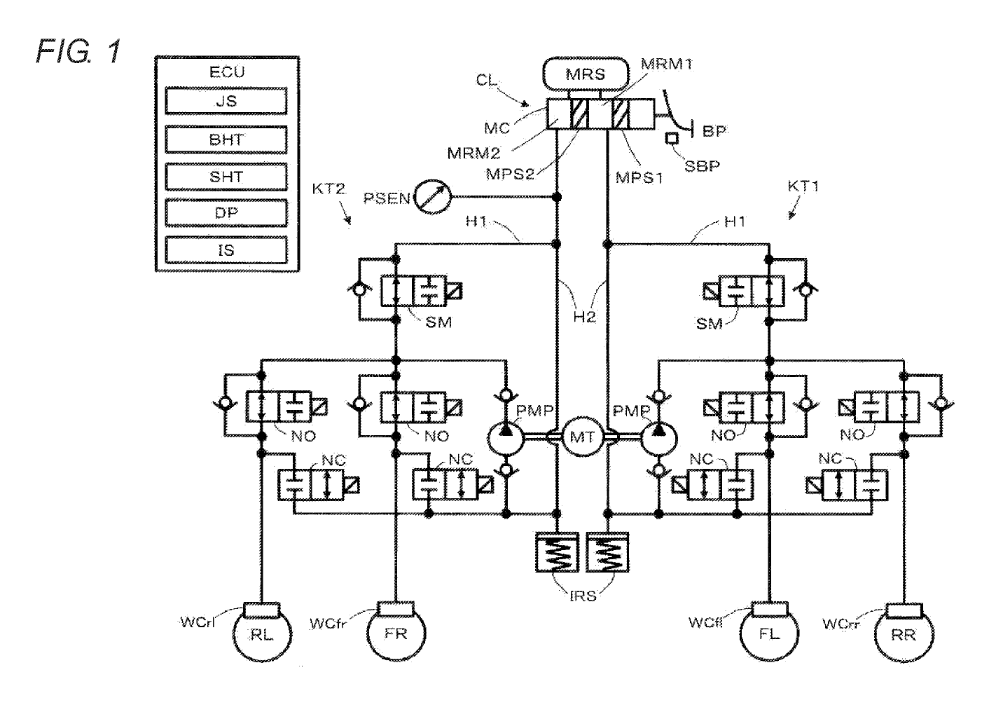

A braking device for a vehicle according to an embodiment of the present invention will be described with reference to an overall configuration view of FIG. 1. The braking device for the vehicle includes a control unit ECU, a braking force operation member BP, a braking force detection unit SBP, a cylinder mechanism CL, a pressure sensor PSEN, a differential pressure valve SM, a holding valve NO, a pressure reduction valve NC, an electric pump PMP, an electric motor MT, an interior reservoir IRS, and wheel cylinders WCfl, WCfr, WCrl, WCrr corresponding to each of a plurality of wheels FL, FR, RL, RR. The braking force operation member BP is connected to the cylinder device CL by way of a connecting member. The cylinder mechanism CL is connected to the differential pressure valve SM by way of a first fluid path H1. Furthermore, the differential pressure valve SM is connected to each wheel cylinder WCfl, WCfr, WCrl, WCrr by way of the holding valve NO. Each wheel cylinder WCfl, WCfr, WCrl, WCrr is connected to the interior reservoir IRS by way of the pressure reduction valve NC. The interior reservoir IRS is connected to the electric pump PMP, and the electric pump PMP is connected to a path between the differential pressure valve SM and the holding valve NO. Furthermore, the interior reservoir IRS is connected to the first fluid path H1 by way of a second fluid path H2. Moreover, the pressure sensor PSEN is arranged on a path between the cylinder mechanism CL and the differential pressure valve SM. The braking force detection unit SBP is, for example, a stroke sensor, and is arranged on the braking force operation member. A means for helping the braking force operation may be arranged between the braking force operation member BP and the master cylinder MC. For example, a negative pressure booster or an electric booster may be arranged.

The cylinder mechanism CL includes a master cylinder MC, master pistons MPS1, MPS2, and a master reservoir MRS. The master pistons MPS1, MPS2 are slidably arranged in the master cylinder MC. The master pistons MPS1, MPS2 partition the master cylinder MC into a first master chamber MRM1 and a second master chamber MRM2. The master reservoir MRS is a reservoir tank including a tube path communicating the first master chamber MRM1 and the second master chamber MRM2. The master reservoir MRS and each master chamber MRM1, MRM2 are communicated/cut off by the movement of the master pistons MPS1, MPS2.

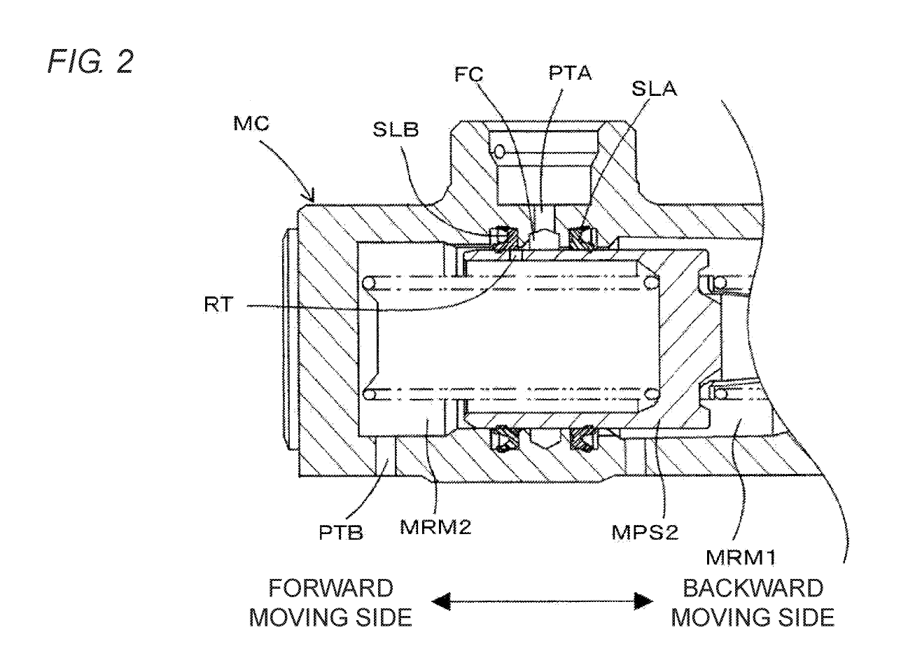

Specifically, a peripheral area of the second master chamber MRM2 will be described. As shown in FIG. 2, the master cylinder MC includes a connection port PTA connected to the master reservoir MRS, seal members SLA, SLB, and a connection port PTB connected to the first fluid path H1. The connection port PTA is a port for communicating the master reservoir MRS and the second master chamber MRM2. The connection port PTA is arranged between the seal members SLA, SLB. In other words, the seal member SLA is arranged on a backward moving side (the right side of FIG. 2) of the connection port PTA, and the seal member SLB is arranged on the forward moving side (the left side of FIG. 2) of the connection port PTA. The seal members SLA, SLB are annular rubber members, and are liquid-tightly brought into contact with an outer peripheral surface of the master piston MPS2. A cross-section cut in a front-rear direction of the seal members SLA, SLB has a convex arc shape (a horseshoe shape) convex toward the connection port PTA side. The seal members SLA, SLB of a first embodiment are cup seals. The seal members SLA, SLB cut off the connection port PTA side (a close side) and an opposite side of the connection port PTA (a far side) with itself as the center. When a pressing force (fluid pressure and gravitational force of the master reservoir MRS) on the connection port PTA side becomes higher than a pressing force (the master pressure) on an opposite side of the connection port PTA, the seal members SLA, SLB are deformed to move away from the master piston MPS2 due to its shape, thus allowing the communication of the connection port PTA and the second master chamber MRM2. A passage RT for communicating an outer peripheral side and an inner peripheral side is formed in the master piston MPS2.

When the master piston MPS2 is at an initial position, the master reservoir MRS and the second master chamber MRM2 are communicated by way of a flow path FC. The flow path FC is configured by the connection port PTA, the inner peripheral surface of the master cylinder MC, the outer peripheral surface of the master piston MPS2, and the passage RT. When the master piston MPS2 is moved forward and the passage RT is moved to the forward moving side of the seal member SLB, the master reservoir MRS and the second master chamber MRM2 are cut off by the seal member SLB. That is, a flow path FC of the braking fluid between the master reservoir MRS and the second master chamber MRM2 is configured to be cut off with the forward movement of the master piston MPS2. Furthermore, as will be described later, the flow path FC is configured to be opened with the activation of the electric pump PMP. The connection port PTB is a port for connecting the second master chamber MRM2 and the first fluid path H1, and is formed on the forward moving side of the seal member SLB of the master cylinder MC. Although a connection port and a seal member are arranged similar to the peripheral area of the second master chamber MRM2 with respect to the first master chamber MRM1, the description thereof will be omitted.

The control unit ECU is an electronic control unit including a CPU, a memory, and the like. A detection result (a detection value) is received from various types of sensors, and current is supplied to the differential pressure valve SM, the holding valve NO, the pressure reduction valve NC, and the electric motor MT, based on the detection result (the detection value) to carry out the control. The control unit includes a state amount acquiring unit JS, a bottoming determination unit BHT, a deceleration slip determination unit SHT, a differential pressure setting unit DP, and a current supplying unit IS. In a normal state (state in which current is not supplied from the current supplying unit IS), the differential pressure valve SM and the holding valve NO are in the open state, the pressure reduction valve NC is in the closed state, and the electric motor MT is in the stopped state. Furthermore, the electric pump PMP is driven when the electric motor MT is driven.

A pressing force generated when the braking force operation member BP is operated is converted to a fluid pressure by the master cylinder MC. Thus, the fluid pressure converted by the master cylinder MC raises the fluid pressure in each wheel cylinder WCfl, WCfr, WCrl, WCrr through the differential pressure valve SM and the holding valve NO. The rise in fluid pressure in each wheel cylinder WCfl, WCfr, WCrl, WCrr displaces a friction member (not shown), thus pressing the friction member against a rotating member (not shown). The rotating member is fixed to each wheel FL, FR, RL, RR, and thus a frictional force is generated between the friction member and the rotating member, and the frictional force generates a braking torque at each wheel FL, FR, RL, RR. As a result, the braking force is generated at each wheel FL, FR, RL, RR, and the travelling vehicle is decelerated.

The control unit ECU executes the bottoming control in which the pressure in the wheel cylinder is increased, in addition to the antiskid control. The bottoming control will be described using a second piping system KT2 by way of example. A first piping system KT1 is similar to the second piping system KT2, and thus the description thereof will be omitted.

The bottoming determination unit BHT determines whether or not a situation of the master cylinder MC is in a bottoming state. Specifically, the bottoming determination unit BHT is recorded in advance with a master pressure (a detection value of the pressure sensor PSEN) at the time when the bottoming occurred in a state in which the electric pump PMP is not activating as a determination value. The bottoming determination unit BHT compares the determination value with the received detection value of the pressure sensor PSEN, and determines as in the “bottoming state” when the detection value is greater than or equal to the determination value.

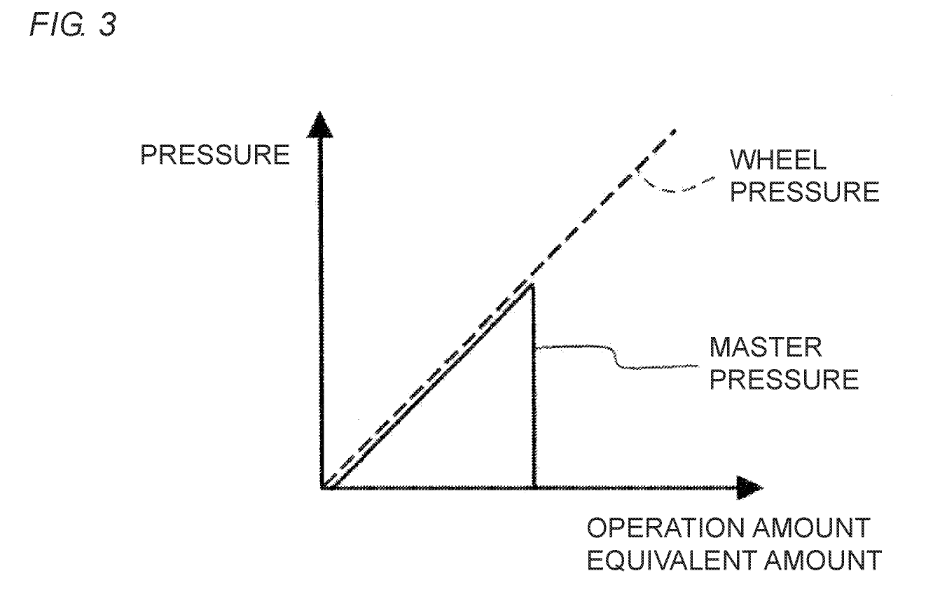

When determined as in the bottoming state by the bottoming determination unit BHT, the current supplying unit IS dives the electric motor MT to drive the electric pump PMP. The drive of the electric pump PMP causes the braking fluid in the second master chamber MRM2 to be discharged to the portion between the differential pressure valve SM and the wheel cylinder WCrl, WCfr. The fluid pressure (the master pressure) of the second master chamber MRM2 becomes an atmospheric pressure or a negative pressure by the outflow of the braking fluid. Thus, the seal member SLB is deformed by the suction of the electric pump PMP, the flow path FC is opened, and the master reservoir MRS and the second master chamber MRM2 are communicated with each other. The drive of the electric pump PMP causes the braking fluid in the master reservoir MRS to be discharged to the portion between the differential pressure valve SM and the wheel cylinder WCrl, WCfr through the second master chamber MRM2. As shown in FIG. 3, the master pressure is lowered by the drive of the pump 57. An operation amount equivalent amount of FIG. 3 is related to the magnitude of the brake operation, and is, for example, a pressing force or a stroke amount.

The state amount acquiring unit JS acquires the detection value of the braking force detection unit SBP, and computes/acquires the operation amount of the braking force operation member BP. The state amount acquiring unit JS computes the operation amount, based on the detection value of the braking force detection unit SBP. The state amount acquiring unit JS acquires the operation amount of the braking force operation member BP while the bottoming state is determined by the bottoming determination unit BHT, and transmits the acquired operation amount to the differential pressure setting unit DP. The operation amount acquired by the state amount acquiring unit JS is based on the stroke value, but for example, may be based on the pressing force or a stroke simulator, and a pressure sensor may be arranged so as to be based on a pressure value. The differential pressure setting unit DP sets the differential pressure state of the differential pressure valve SM so that the wheel pressure corresponding to the target braking force is generated to generate the target braking force corresponding to the received operation amount. The differential pressure setting unit DP instructs the current supplying unit IS to supply the current corresponding to the set differential pressure. The current supplying unit IS supplies current to the differential pressure valve SM to generate a desired differential pressure with respect to both sides of the differential pressure valve SM in the bottoming state. Thus, as shown in FIG. 3, the wheel pressure (i.e., the braking force) corresponding to the brake operation can be exerted even after the bottoming state is obtained.

Next, the pressure reduction control, which is one part of the antiskid control, will be described using the second piping system KT2 by way of example. The pressure reduction slip determination unit SHT determines whether or not the deceleration slip is occurring in the vehicle. To determine whether or not the pressure reduction slip is occurring, for example, a wheel speed is acquired from the detection value of a wheel speed sensor (not shown). A vehicle body speed based on the wheel speed is computed by the state amount acquiring unit JS. A wheel state amount (e.g., wheel deceleration, slip) is computed based on the wheel speed and the vehicle body speed obtained in such a manner. The pressure reduction slip determination unit SHT determines that the deceleration slip is occurring when the wheel state amount is greater than a predetermined threshold value.

When determined that the deceleration slip is occurring, the current is supplied from the current supplying unit IS to the holding valve NO and the pressure reduction valve NC, so that the holding valve NO is in the closed state and the pressure reduction valve NC is in the open state, whereby the braking fluid in the wheel cylinders WCrl, WCfr flow out to the interior reservoir IRS. Therefore, the pressure in the wheel cylinders WCrl, WCfr is reduced. Furthermore, as the braking fluid accumulated in the interior reservoir IRS is suctioned, the current supplying unit IS supplies current to the electric motor MT. As a result, the electric pump PMP is driven, and the braking fluid accumulated in the interior reservoir IRS is discharged to the path between the differential pressure valve SM and the holding valve NO.

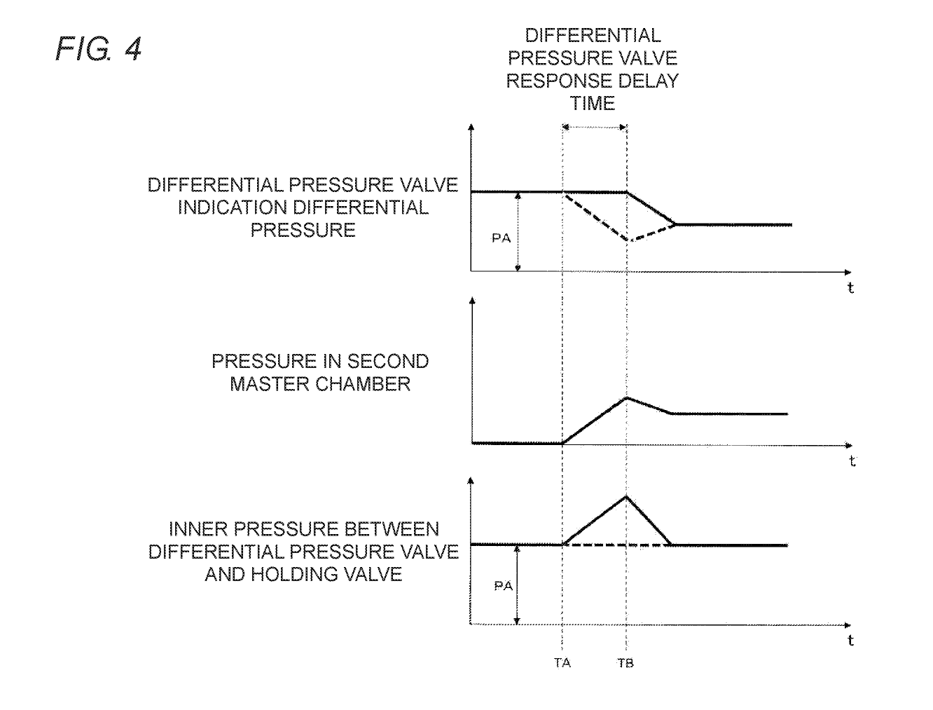

In a situation of the state transition from the bottoming control (electric pump: ON, differential pressure valve SM: differential pressure is present) to the pressure reduction control (electric pump: ON, holding valve NO: closed state, pressure reduction valve NC: open state), the operation of FIG. 4 is obtained. According to the bottoming control, the second master chamber MRM2 becomes an atmospheric pressure or a negative pressure by the outflow of the braking fluid. The differential pressure valve indication differential pressure is set to PA by the differential pressure setting unit DP, and the inner pressure between the differential pressure valve SM and the holding valve NO becomes PA to generate the wheel pressure corresponding to the target braking force. The pressure reduction control is started at time TA, and the pressure in the second master chamber MRM2 is rapidly raised through the differential pressure valve SM. The differential pressure valve indication differential pressure set by the differential pressure setting unit DP is set based on the detection value (the pressure in second master chamber) of the pressure sensor PSEN, and a behavior indicated with a broken line is ideally realized. However, since the differential pressure valve SM responds when the differential pressure setting unit DP acquires the sensor value, the differential pressure valve indication differential pressure is computed and converted to the current value, and thereafter information is transmitted to the current supplying unit IS, and the current supplying unit IS supplies current to the differential pressure valve SM, the response delay occurs and the behavior indicated with a solid line is realized. The path between the differential pressure valve SM and the holding valve NO is the sum of the pressure in the second master chamber MRM2 and the differential pressure set by the differential pressure setting unit DP, and thus the path between the differential pressure valve SM and the holding valve NO becomes to have a higher pressure. After time TB, the response delay is resolved and the differential pressure valve indication differential pressure reduces from PA, whereby the path between the differential pressure valve SM and the holding valve NO is no longer in the higher pressure state. In the present invention, a method of preventing the path between the differential pressure valve SM and the holding valve NO from becoming to have a higher pressure caused by the response delay of the differential pressure valve SM will be disclosed in a set example, to be described later.

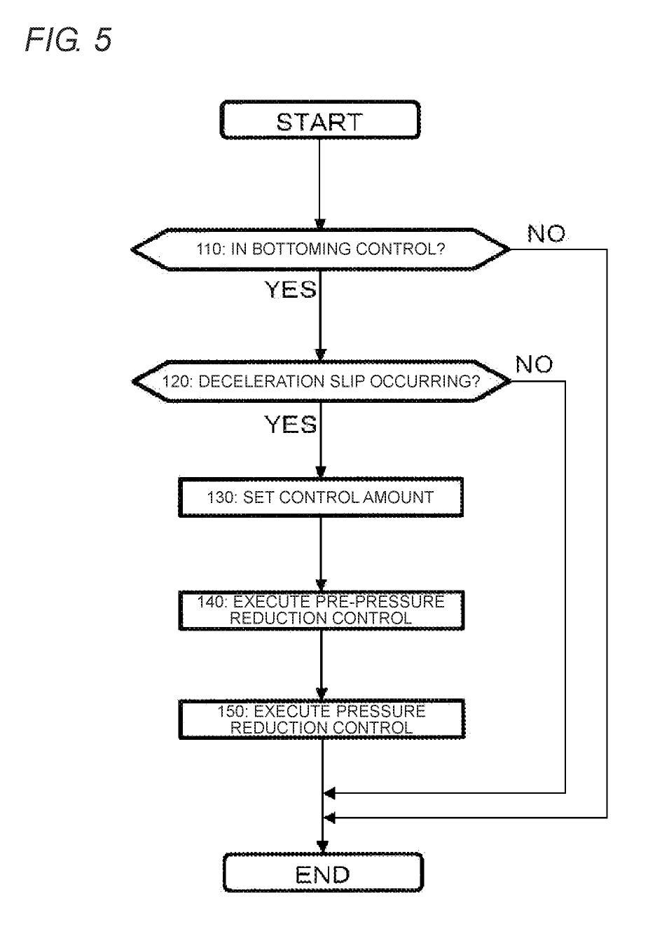

In the present embodiment, when an engine of the vehicle is turned ON (i.e., when an ignition switch (not shown) is turned ON), the electronic control unit ECU executes a control program shown in FIG. 5, and repeatedly carries out the program until the engine is stopped (i.e., the ignition switch is turned OFF).

When the ignition switch is turned ON, the processing shown in FIG. 5 is started. First, whether or not in the bottoming control is determined in step 110. The processing proceeds to step 120 if in the bottoming control, and the processing is terminated if not in the bottoming control. Next, whether or not the deceleration slip is occurring is determined in step 120. The processing proceeds to step 130 when the deceleration slip is occurring, and the processing is terminated when the deceleration slip is not occurring. In step 130, the control amount is set by the control unit ECU. Specifically, the current amount to be supplied to the differential pressure valve SM, the holding valve NO, the pressure reduction valve NC, and the electric motor MT is set based on the state amount acquired when whether the presence or absence of occurrence of the deceleration slip of step 120 is determined. Next, the processing proceeds to step 140, and the pre-pressure reduction control is executed. This is a step of carrying out the control beforehand to prevent the path between the differential pressure valve SM and the holding valve NO from becoming to have a higher pressure immediately after the start of the pressure reduction control. Thereafter, the processing proceeds to step 150, and the pressure reduction control is executed. After step 150 ends, the processing is terminated. Furthermore, in the present control flow, step 140 does not necessarily need to be performed, and the path between the differential pressure valve SM and the holding valve NO may be prevented from becoming to have a higher pressure by changing the method of executing the pressure reduction control of step 150.

### First Set Example

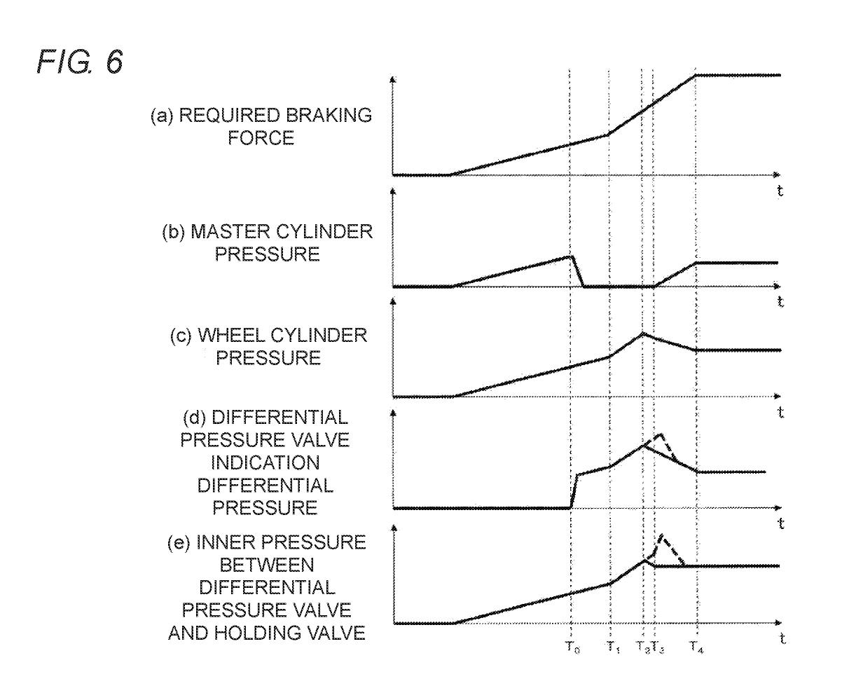

The behavior when preventing the path between the differential pressure valve SM and the holding valve NO from becoming to have a higher pressure by pressure-adjusting the differential pressure valve SM before the pressure reduction control will be described using FIG. 6. At time T0, the bottoming control is started. At time T1, (a) the increase gradient of the required braking force is raised. As a result, at time T2, the determination is made that the deceleration slip is occurring (step 120), and the control amount of the differential pressure valve SM is set in step 130 by the state amount (e.g., wheel deceleration, slip) acquired in step 120. The pre-pressure reduction control is carried out in step 140, and (b) the differential pressure valve indication differential pressure is reduced. Thus, (c) the wheel cylinder pressure, and (e) the internal pressure between the differential pressure valve and the holding valve are also reduced. At time T3, the pressure reduction control is executed (step 150). (b) The master cylinder pressure is raised by the execution of the pressure reduction control, but (d) the differential pressure valve indication differential pressure is reduced by (b) the rise of the master cylinder pressure, and thus (e) the internal pressure between the differential pressure valve and the holding valve does not change. The pressure reduction control is terminated at time T4, and the holding state (holding valve NO: closed state, pressure reduction valve NC: closed state, electric pump: stop) is obtained. Furthermore, the broken line in the figure is the behavior when the present invention is not performed. The pre-pressure reduction control is not carried out, and with the influence of the response delay of the differential pressure valve SM, (e) the internal pressure between the differential pressure valve and the holding valve is rapidly raised for a predetermined time from time T3.

### Second Set Example

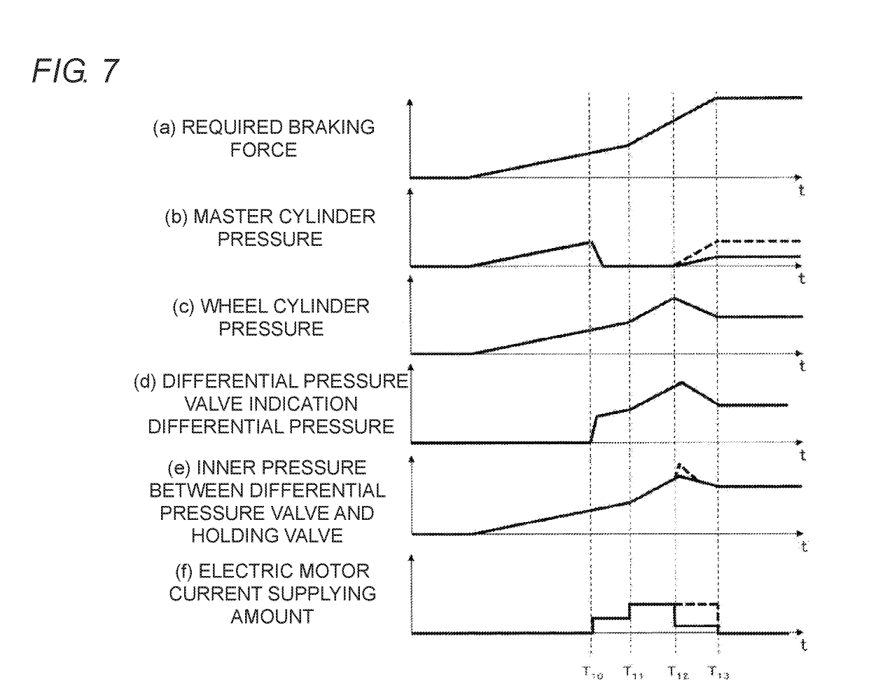

The behavior when preventing the path between the differential pressure valve SM and the holding valve NO from becoming to have a higher pressure by lowering the ejection amount of the electric pump PMP for a predetermined period immediately after the start of the pressure reduction control will be described using FIG. 7. At time T10, the bottoming control is started. At time T11, (a) the increase gradient of the required braking force is raised. As a result, at time T12, the determination is made that the deceleration slip is occurring (step 120), and (f) the electric motor current supplying amount correlated with the ejection amount of the electric pump is set in step 130 by the state amount (e.g., wheel deceleration, slip) acquired in step 120. (f) The electric motor current supplying amount is set to be low to lower the ejection amount of the electric pump at the start of the pressure reduction control. In the present set example, the processing of step 140 is omitted. The pressure reduction control is executed from time T12 (step 150). The pressure reduction control is terminated at T13, and the holding state (holding valve NO: closed state, pressure reduction valve NC: closed state, electric pump: stop) is obtained. Since (f) the electric motor current supplying amount is set to be low, (b) the rise gradient of the master cylinder pressure is smaller compared to when the present set example is not performed (the broken line in the figure), and thus (e) the internal pressure between the differential pressure valve and the holding valve becomes a lower value.

### Third Set Example

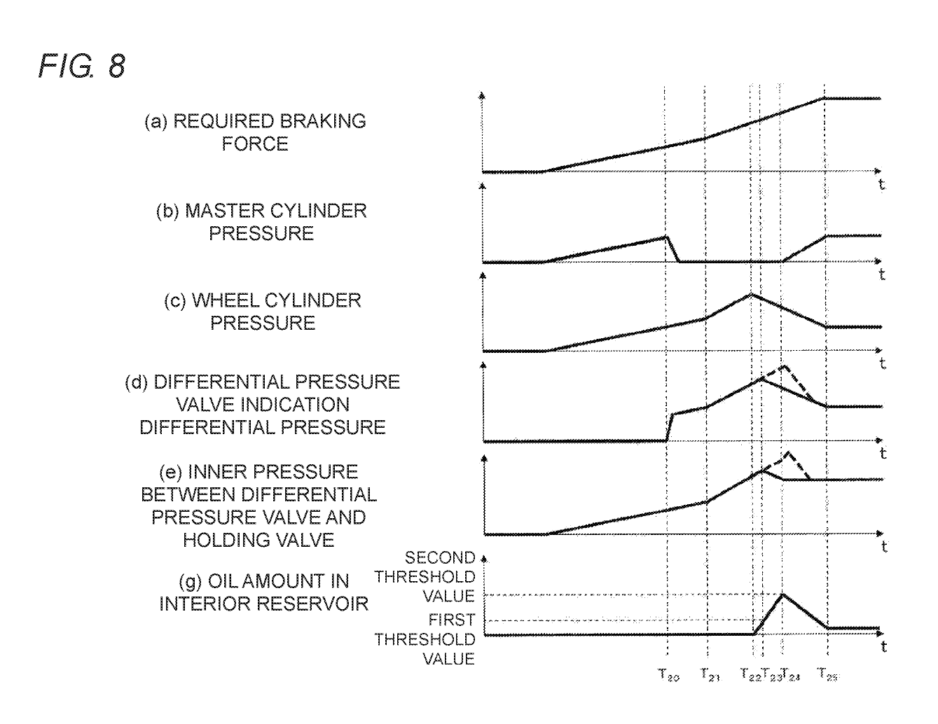

The behavior of preventing the path between the differential pressure valve SM and the holding valve NO from becoming to have a higher pressure by lowering the differential pressure formed by the differential pressure valve SM when the oil amount in the interior reservoir IRS becomes greater than or equal to a first threshold value, and by activating the electric pump PMP when the oil amount in the interior reservoir IRS becomes greater than or equal to a second threshold value greater than the first threshold value will be described using FIG. 8. At time T20, the bottoming control is started. At time T21, (a) the increase gradient of the required braking force is raised. As a result, at time T22, the determination is made that the deceleration slip is occurring (step 120), and the control amount of the pressure reduction control is set in step 130 by the state amount (e.g., wheel deceleration, slip) acquired in step 120. In the present set example, the processing of step 140 is omitted. The pressure reduction control is executed from time T22 (step 150). In the present set example, the pressure reduction valve NC is in the open state by the pressure reduction control, and (c) the wheel cylinder pressure is reduced, but the electric pump PMP is stopped because the oil amount of the interior reservoir IRS is smaller than the second threshold value. Thus, (b) the master cylinder pressure does not increase. At time T23, the oil amount of the interior reservoir IRS becomes greater than or equal to the first threshold value, and thus (d) the differential pressure valve indication differential pressure is reduced. At time T24, the oil amount of the interior reservoir IRS becomes greater than or equal to the second threshold value, and thus the electric pump PMP is activated. Therefore, (b) the master cylinder pressure is raised from time T24. In the present set example, (d) the differential pressure valve indication differential pressure is reduced before the electric pump PMP is activated, and thus (e) the internal pressure between the differential pressure valve and the holding valve is reduced compared to (d) when the differential pressure valve indication differential pressure is not reduced (the broken line in the figure). The pressure reduction control is terminated at time T25, and the holding state (holding valve NO: closed state, pressure reduction valve NC: closed state, electric pump: stop) is obtained.

### Fourth Set Example

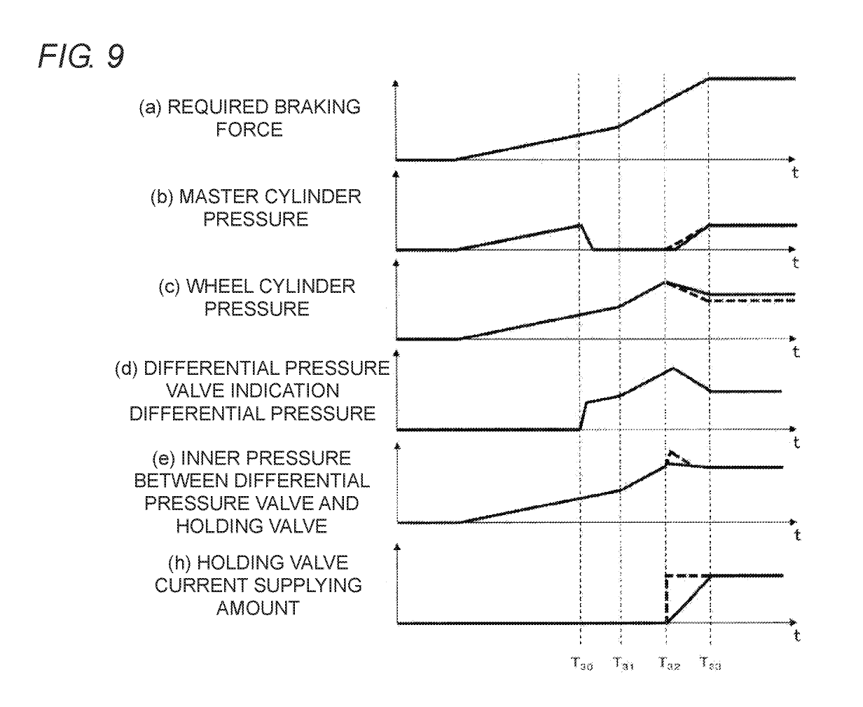

The behavior when preventing the path between the differential pressure valve SM and the holding valve NO from becoming to have a higher pressure by adjusting the current to supply to the holding valve NO will be described using FIG. 9. At time T30, the bottoming control is started. At time T31, (a) the increase gradient of the required braking force is raised. As a result, at time T32, the determination is made that the deceleration slip is occurring (step 120), and the control amount of the pressure reduction control is set in step 130 by the state amount (e.g., wheel deceleration, slip) acquired in step 120. In the present set example, the processing of step 140 is omitted. The state transitions to the pressure reduction control from time T32 (step 150). In the present set example, the current flowing to the holding valve NO is controlled by the DUTY control. (h) The holding valve current supplying amount is gradually increased after time T32. When (h) the holding valve current supplying amount is small, the differential pressure between the path between the differential pressure valve SM and the holding valve NO formed by the holding valve NO and the wheel cylinders become smaller. That is, since (h) the smaller the holding valve current supplying amount is, the more the braking fluid leaks to the wheel cylinder through the holding valve NO (since the holding valve NO is not in a completely closed state), the inner pressure in the path between the differential pressure valve SM and the holding valve NO is reduced compared to when the present set example is not performed (the broken line in the figure). The pressure reduction control is terminated at time T33, and the holding state (holding valve NO: closed state, pressure reduction valve NC: closed state, electric pump: stop) is obtained.

### Fifth Set Example

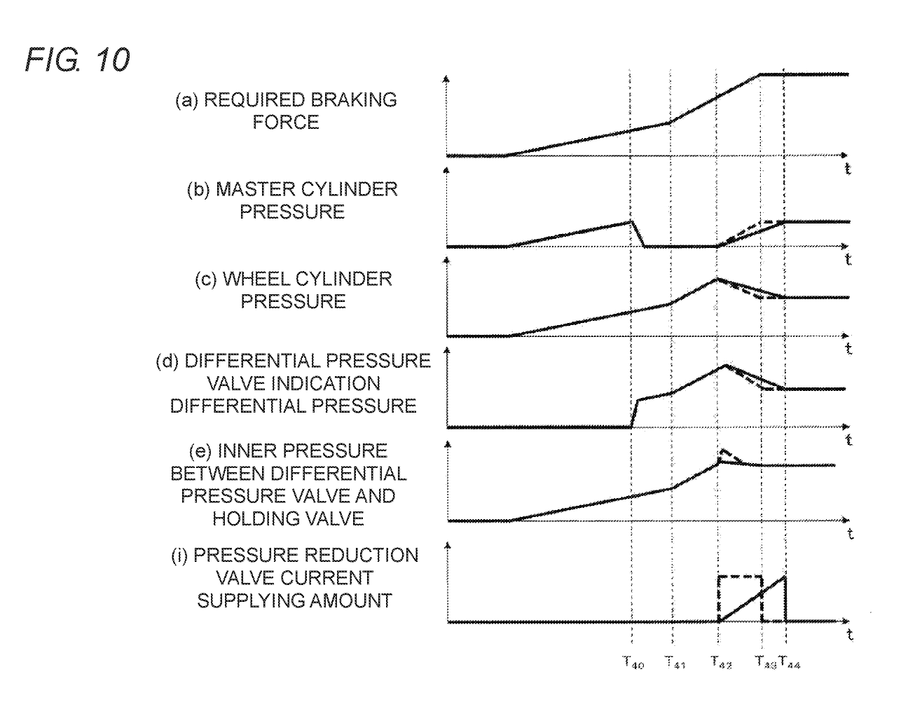

The behavior when preventing the path between the differential pressure valve SM and the holding valve NO from becoming to have a higher pressure by adjusting the current to supply to the pressure reduction valve NC will be described using FIG. 10. At time T40, the bottoming control is started. At time T41, (a) the increase gradient of the required braking force is raised. As a result, at time T42, the determination is made that the deceleration slip is occurring (step 120), and the control amount of the pressure reduction control is set in step 130 by the state amount (e.g., wheel deceleration, slip) acquired in step 120. In the present set example, the processing of step 140 is omitted. The state transitions to the pressure reduction control from time T42 (step 150). In the present set example, the current flowing to the pressure reduction valve NC is controlled by the DUTY control. (i) The pressure reduction valve current supplying amount is gradually increased after time T42. (i) When the pressure reduction valve current supplying amount is small, the differential pressure between the wheel cylinder and the interior reservoir IRS formed by the pressure reduction valve NC becomes larger. That is, since the smaller the pressure reduction valve current supplying amount is, the less the braking fluid leaks to the interior reservoir IRS through the pressure reduction valve NC (since the pressure reduction valve NC is not in a completely open state), the speed at which the oil amount of the interior reservoir IRS is accumulated becomes slower. Since the speed at which the oil amount of the interior reservoir IRS is accumulated is slower, that is, the oil amount of the interior reservoir IRS is small, the amount of braking fluid supplied to the path between the differential pressure valve SM and the holding valve NO is reduced by the electric pump PMP. As a result, (e) the inner pressure in the differential pressure valve and the holding valve becomes lower compared to when the present set example is not performed (the broken line in the figure). When the present set example is not performed at the time point of T43, (c) the wheel cylinder pressure is reduced by a necessary amount, and the holding state (holding valve NO: closed state, pressure reduction valve NC: closed state, electric pump: stop) is obtained, but in the present set example, the pressure decrease gradient is low, and thus the pressure reduction control is terminated at time T44 and the holding state is obtained.

In the fifth set example, the pressure decrease speed becomes lower compared to when the fifth set example is not performed, and thus the desired performance is not obtained (the wheel is easily locked) in the antiskid control. Thus, in the fifth set example, the durability of the device can be enhanced while approaching the ideal performance by quickening the intervening timing of the antiskid control (e.g., by performing the pressure reduction control from the time point when the slip is low).

Next, the effects obtained by the present embodiment will be described. (1) When the execution of the state transition from the bottoming control to the pressure reduction control is determined, the control unit ECU reduces the amount of braking fluid accumulated in the path between the differential pressure valve SM and the holding valve NO, and thus can prevent the path from becoming to have a higher pressure. Therefore, the durability of the braking device for the vehicle can be enhanced.

(2) Before the execution of the state transition from the bottoming control to the pressure reduction control, the differential pressure formed by the differential pressure valve SM is lowered by the control unit ECU, so that the amount of braking fluid flowing out to the master cylinder MC from the path between the differential pressure valve SM and the holding valve NO increases. As a result, the amount of braking fluid accumulated in the path between the differential pressure valve SM and the holding valve NO is reduced, and the path can be prevented from becoming to have a higher pressure. Therefore, the durability of the braking device for the vehicle can be enhanced.

(3) The amount of braking fluid supplied to the path between the differential pressure valve and the holding valve is reduced, and the path can be prevented from becoming to have a higher pressure by lowering the ejection amount of the electric pump for a predetermined time from the start of the pressure reduction control. Therefore, the durability of the braking device for the vehicle can be enhanced. Furthermore, the braking fluid in the interior reservoir IRS can be rapidly suctioned after elapse of the predetermined time from the start of the pressure reduction control by lowering the ejection amount only for the predetermined time when the response delay of the differential pressure valve SM occurs.

(4) During the predetermined period from the start of the pressure reduction mode in which the response delay of the differential pressure valve SM occurs, the oil amount of the interior reservoir IRS is increased by the pressure reduction control, but the second threshold value for activating the electric pump PMP is greater than the first threshold value for lowering the differential pressure formed by the differential pressure valve SM, and hence the amount of braking fluid accumulated in the path between the differential pressure valve SM and the holding valve NO can be reduced, and the path can be prevented from becoming to have a before the electric pump PMP is activated. Therefore, the durability of the braking device for the vehicle can be enhanced.

(5) In the state transition from the bottoming control to the pressure reduction control, the control unit ECU delays the state transition of the holding valve NO from the open state to the closed state, so that the amount of braking fluid flowing out to the wheel cylinder from the path between the differential pressure valve SM and the holding valve NO increases. As a result, the amount of braking fluid accumulated in the path between the differential pressure valve SM and the holding valve NO is reduced, and the path can be prevented from becoming to have a higher pressure. Therefore, the durability of the braking device for the vehicle can be enhanced.

(6) In the state transition from the bottoming control to the pressure reduction control, the control unit ECU delays the state transition of the pressure reduction valve NC from the closed state to the open state, so that the speed at which the braking fluid is accumulated in the interior reservoir IRS becomes slower. As a result, the amount of braking fluid supplied to the path by the electric pump PMP is reduced. Therefore, the amount of braking fluid accumulated in the path of immediately after the state transition from the bottoming control to the pressure reduction control is reduced, and the path can be prevented from becoming to have a higher pressure. Therefore, the durability of the braking device for the vehicle can be enhanced.

The embodiment of the present invention has been described above in detail, but the present invention can be subjected to various design changes within a scope not deviating from the gist of the invention.

A pressure sensor PSEN2 may be arranged on the path between the differential pressure valve SM and the holding valve NO, and the differential pressure in the differential pressure valve SM may be adjusted based on the pressure value thereof. In the state transition from the bottoming control to the pressure reduction control, the pressure value of the pressure sensor PSEN2 starts to rise earlier than the pressure sensor PSEN starts to rise. Thus, the differential pressure valve SM can be pressure-adjusted from an earlier state compared to when controlling the differential pressure valve SM based on the detection value of the pressure sensor PSEN. Therefore, the path between the differential pressure valve SM and the holding valve NO can be prevented from becoming to have a higher pressure, and the durability of the braking device for the vehicle can be enhanced.

In the fourth set example, the holding valve current flowing amount is gradually increased as a method of delaying the state transition of the holding valve NO from the open state to the closed state, but for example, the timing of supplying the current to the holding valve NO may be delayed. Similarly when delaying the state transition of the pressure reduction valve NC from the closed state to the open state in the fifth set example, the timing of supplying the current to the pressure reduction valve NC may be delayed. Furthermore, in the fifth set example, the pressure reduction valve NC may be opened/closed on a predetermined cycle after delaying the timing of supplying the current to the pressure reduction valve NC. Thus, the braking fluid in the wheel cylinder flows out to the interior reservoir IRS only during the time when the current is supplied to the pressure reduction valve NC and the valve is in the open state, and thus the oil amount of the interior reservoir IRS is further reduced. As a result, the amount of braking fluid supplied to the path between the differential pressure valve SM and the holding valve NO by the electric pump PMP is further reduced, whereby the path between the differential pressure valve SM and the holding valve NO can be prevented from becoming to have a higher pressure.

1. A braking device for a vehicle comprising:
a master cylinder that converts a required braking force to a fluid pressure, a wheel cylinder that applies, to a wheel of a vehicle, a braking force corresponding to an input fluid pressure;
a differential pressure valve arranged between the master cylinder and the wheel cylinder to adjust a differential pressure between the master cylinder and the wheel cylinder;
a holding valve arranged between the differential pressure valve and the wheel cylinder to adjust a communicating state of the differential pressure valve and the wheel cylinder, a reservoir that stores braking fluid
a pressure reduction valve arranged between the wheel cylinder and the reservoir to adjust a communicating state of the wheel cylinder and the reservoir;
an electric pump that ejects the braking fluid in the reservoir to a portion between the differential pressure valve and the holding valve; and
a fluid path connected to the reservoir from a master cylinder side of the differential pressure valve,
the braking device for the vehicle carrying out a control of the differential pressure valve, the holding valve, the pressure reduction valve, and the electric pump,
the braking device for the vehicle comprising:
a determining unit that determines execution of a state transition from a pressure increase mode of activating the electric pump with the differential pressure valve in a closed state and the holding valve in an open state to a pressure reduction mode of activating the electric pump with the holding valve in the closed state and the pressure reduction valve in the open state; and
a control unit that carries out the control of any one or more of the differential pressure valve, the holding valve, the pressure reduction valve, and the electric pump as a result of the determination of the execution of the state transition by the determining unit, and reduces an amount of braking fluid to be accumulated in a path between the differential pressure valve and the holding valve.

2. The braking device for the vehicle according to claim 1, wherein the control unit executes the state transition from the pressure increase mode to the pressure reduction mode after lowering the differential pressure formed by the differential pressure valve to reduce the amount of the braking fluid to be accumulated in the path between the differential pressure valve and the holding valve.

3. The braking device for the vehicle according to claim 1 or 2, wherein the control unit lowers an ejection amount of the electric pump for a predetermined period from a start of the pressure reduction mode to reduce the amount of the braking fluid to be accumulated in the path between the differential pressure valve and the holding valve.

4. The braking device for the vehicle according to claim 1, wherein the control unit lowers the differential pressure formed by the differential pressure valve when an oil amount in the reservoir becomes greater than or equal to a first threshold value, and activates the electric pump when the oil amount in the reservoir becomes greater than or equal to a second threshold value greater than the first threshold value, for a predetermined period from the start of the pressure reduction mode to reduce the amount of the braking fluid to be accumulated in the path between the differential pressure valve and the holding valve.

5. The braking device for the vehicle according to claim 1, wherein the control unit delays the state transition of the holding valve from the open state to the closed state in the state transition from the pressure increase mode to the pressure reduction mode to reduce the amount of the braking fluid to be accumulated in the path between the differential pressure valve and the holding valve.

6. The braking device for the vehicle according to claim 1, wherein the control unit delays the state transition of the pressure reduction valve from the closed state to the open state in the state transition from the pressure increase mode to the pressure reduction mode to reduce the amount of the braking fluid to be accumulated in the path between the differential pressure valve and the holding valve.

7. The braking device for the vehicle according to claim 2, wherein the control unit lowers an ejection amount of the electric pump for a predetermined period from a start of the pressure reduction mode to reduce the amount of the braking fluid to be accumulated in the path between the differential pressure valve and the holding valve.

8. The braking device for the vehicle according to claim 2, wherein the control unit lowers the differential pressure formed by the differential pressure valve when an oil amount in the reservoir becomes greater than or equal to a first threshold value, and activates the electric pump when the oil amount in the reservoir becomes greater than or equal to a second threshold value greater than the first threshold value, for a predetermined period from the start of the pressure reduction mode to reduce the amount of the braking fluid to be accumulated in the path between the differential pressure valve and the holding valve.

9. The braking device for the vehicle according to claim 3, wherein the control unit lowers the differential pressure formed by the differential pressure valve when an oil amount in the reservoir becomes greater than or equal to a first threshold value, and activates the electric pump when the oil amount in the reservoir becomes greater than or equal to a second threshold value greater than the first threshold value, for a predetermined period from the start of the pressure reduction mode to reduce the amount of the braking fluid to be accumulated in the path between the differential pressure valve and the holding valve.

10. The braking device for the vehicle according to claim 7, wherein the control unit lowers the differential pressure formed by the differential pressure valve when an oil amount in the reservoir becomes greater than or equal to a first threshold value, and activates the electric pump when the oil amount in the reservoir becomes greater than or equal to a second threshold value greater than the first threshold value, for a predetermined period from the start of the pressure reduction mode to reduce the amount of the braking fluid to be accumulated in the path between the differential pressure valve and the holding valve.

11. The braking device for the vehicle according to claim 2, wherein the control unit delays the state transition of the holding valve from the open state to the closed state in the state transition from the pressure increase mode to the pressure reduction mode to reduce the amount of the braking fluid to be accumulated in the path between the differential pressure valve and the holding valve.

12. The braking device for the vehicle according to claim 3, wherein the control unit delays the state transition of the holding valve from the open state to the closed state in the state transition from the pressure increase mode to the pressure reduction mode to reduce the amount of the braking fluid to be accumulated in the path between the differential pressure valve and the holding valve.

13. The braking device for the vehicle according to claim 7, wherein the control unit delays the state transition of the holding valve from the open state to the closed state in the state transition from the pressure increase mode to the pressure reduction mode to reduce the amount of the braking fluid to be accumulated in the path between the differential pressure valve and the holding valve.

14. The braking device for the vehicle according to claim 4, wherein the control unit delays the state transition of the holding valve from the open state to the closed state in the state transition from the pressure increase mode to the pressure reduction mode to reduce the amount of the braking fluid to be accumulated in the path between the differential pressure valve and the holding valve.

15. The braking device for the vehicle according to claim 8, wherein the control unit delays the state transition of the holding valve from the open state to the closed state in the state transition from the pressure increase mode to the pressure reduction mode to reduce the amount of the braking fluid to be accumulated in the path between the differential pressure valve and the holding valve.

16. The braking device for the vehicle according to claim 9, wherein the control unit delays the state transition of the holding valve from the open state to the closed state in the state transition from the pressure increase mode to the pressure reduction mode to reduce the amount of the braking fluid to be accumulated in the path between the differential pressure valve and the holding valve.

17. The braking device for the vehicle according to claim 10, wherein the control unit delays the state transition of the holding valve from the open state to the closed state in the state transition from the pressure increase mode to the pressure reduction mode to reduce the amount of the braking fluid to be accumulated in the path between the differential pressure valve and the holding valve.

18. The braking device for the vehicle according to claim 2, wherein the control unit delays the state transition of the pressure reduction valve from the closed state to the open state in the state transition from the pressure increase mode to the pressure reduction mode to reduce the amount of the braking fluid to be accumulated in the path between the differential pressure valve and the holding valve.

19. The braking device for the vehicle according to claim 3, wherein the control unit delays the state transition of the pressure reduction valve from the closed state to the open state in the state transition from the pressure increase mode to the pressure reduction mode to reduce the amount of the braking fluid to be accumulated in the path between the differential pressure valve and the holding valve.

20. The braking device for the vehicle according to claim 4, wherein the control unit delays the state transition of the pressure reduction valve from the closed state to the open state in the state transition from the pressure increase mode to the pressure reduction mode to reduce the amount of the braking fluid to be accumulated in the path between the differential pressure valve and the holding valve.
